(19) United States
(12) Patent Application Publication
(10) Pub. No.: US 2023/0205299 A1
(43) Pub. Date: Jun. 29, 2023

(54) DEVICE DEACTIVATION

(71) Applicant: HEWLETT-PACKARD DEVELOPMENT COMPANY, L.P., SPRING, TX (US)

(72) Inventor: ISAAC LAGNADO, SPRING, TX (US)

(21) Appl. No.: 17/995,949

(22) PCT Filed: Apr. 16, 2020
(86) PCT No.: PCT/US20/28514

§ 371 Date: Oct. 11, 2022

(51) Int. Cl. G06F 1/3212; H04W 52/02

(52) U.S. Cl. CPC G06F 1/3212; H04W 52/0277

(57) ABSTRACT

Examples of electronic devices are described herein. In some examples, an electronic device includes a tracking device. In some examples, the electronic device includes a controller. In some examples, the controller may be to detect a power condition of the electronic device. In some examples, the controller may be to set a timer to deactivate the tracking device in response to detecting the power condition.

### BACKGROUND

Electronic technology has advanced to become virtually ubiquitous in society and has been used to improve many activities in society. For example, electronic devices are used to perform a variety of tasks, including work activities, communication, research, and entertainment. Different varieties of electronic circuits may be utilized to provide different varieties of electronic technology.

### BRIEF DESCRIPTION OF THE DRAWINGS

FIG. 1 is a block diagram of an example of an electronic device that may be utilized for tracking device deactivation control;

FIG. 2 is a block diagram of an example of an electronic device that may be utilized for tracking device deactivation control;

FIG. 3 is a block diagram of an example of a host device that may be utilized for deactivation control;

FIG. 4 is a block diagram illustrating an example of a computer-readable medium for controlling device deactivation; and

FIG. 5 is a flow diagram illustrating an example of a method for controlling device deactivation.

### DETAILED DESCRIPTION

An electronic device may be a device that includes electronic circuitry. For instance, an electronic device may include integrated circuitry (e.g., transistors, digital logic, semiconductor technology, etc.). Examples of electronic devices include computing devices, laptop computers, desktop computers, smartphones, tablet devices, wireless communication devices, game consoles, smart appliances, vehicles with electronic components, aircraft, drones, robots, smart appliances, etc.

A tracking device may be a device to provide location and/or tracking functionality. For example, a tracking device may utilize wireless signaling to indicate a current and/or past location of the tracking device. In some examples, a tracking device may transmit a signal (e.g., beacon, advertisement signal, etc.) that may indicate a location of the tracking device and/or may indicate a proximity of the tracking device to a receiving device.

In some examples of the electronic devices described herein, a tracking device, other wireless communication device (e.g., Internet of Things (IoT) device), and/or physical characteristic sensor (e.g., motion sensor, fingerprint reader, touch screen, image sensor, etc.) may be included in and/or integrated into an electronic device. A tracking device and/or other wireless communication device may be utilized to track, locate, and/or send a signal to the electronic device and/or from the electronic device. A physical characteristic sensor may be a sensor to sense and/or indicate a physical characteristic (e.g., motion, contact, touch, light, color, etc.). In some examples, a received signal and/or a change in the physical sensor input may be utilized to wake the electronic device into a higher-powered operating state. In some examples, the tracking device, other wireless communication device, and/or physical characteristic sensor may remain powered when other electronic device resources and/or components (e.g., display, central processing unit (CPU), non-volatile memory, cameras, and/or ports, etc.) are powered off.

The tracking device, other wireless communication device, and/or physical characteristic sensor may consume power from a power source or power sources (e.g., battery or batteries) of the electronic device. For example, the electronic device may provide power on a power rail or power rails from a power source or sources. A power rail may be a connection (e.g., wire, conductor, trace, etc.) to a power source (e.g., power supply, battery, etc.). For example, an electronic device may include multiple power rails to supply power to resource(s) and/or component(s) in accordance with an operating state of the electronic device.

An operating state may be a degree of operation of an electronic device. Different operating states may be associated with different power rail activity. Examples of operating states may include an active (e.g., “on”) state, a standby state, and/or an “off” state. In some examples of an active state, all or most electronic device resources and/or components are active (e.g., all power rails may be active). In some examples of a standby state, some of the resources and/or components may be deactivated. For instance, display(s), camera(s), port(s), etc., may be deactivated in the standby state. In some examples of the standby state, a power rail or rails may be deactivated, which may deactivate a resource(s) and/or component(s) to conserve power. In some examples of the off state, a selected power rail or power rails for a selected resource(s) and/or component(s) may be active, while another power rail or power rails may be deactivated. In some examples, a reserve power mode or operating state may be a state in which one power rail (e.g., a last power rail, a reserve power rail) is active.

An example of a selected power rail may be referred to as a reserve power rail. A reserve power rail may be a power rail that may remain active while a power source may be able to supply power. For example, the reserve power rail may be a last power rail to remain active while the electronic device is in an off state and/or while all other power rail(s) are inactive or deactivated. For instance, the reserve power rail may be the last active power rail and/or a last power rail to lose power as a power source or sources may be diminished. In some examples, the reserve power rail may provide power to a clock (e.g., real-time clock (RTC)), memory (e.g., volatile memory, memory to maintain Basic Input/Output System (BIOS) data and/or settings, etc.), and/or other selected resource(s) and/or component(s). For instance, the reserve power rail may be utilized to maintain basic functionality (e.g., a clock and/or BIOS data and/or settings) while the electronic device is in an off state. In some examples, the reserve power rail may be designed to power basic functionality from a power source (e.g., battery) for an extended period of time (e.g., months, a year, 2.5 years, etc.).

Table (1) illustrates an example of power rail activity according to operating state, where “X” denotes a deactivated power rail and “0” denotes an active power rail. Power rails may supply voltages in Volts (V). In other examples, different numbers and/or types of power rails may be utilized.

TABLE 1

| | | | | | | |
|---|---|---|---|---|---|---|
| Rail | Voltage | Reset | Reserve | Off | Standby | On |

| | | | | | | | |
|---|---|---|---|---|---|---|---|
| Reserve | 3.3 | V | X | ◯ | ◯ | ◯ | ◯ |

| | | | | | | | | |
|---|---|---|---|---|---|---|---|---|
| 3.3 | (A) | 3.3 | V | X | X | ◯ | ◯ | ◯ |
| 3.3 | (B) | 3.3 | V | X | X | X | X | ◯ |
| 5 | (A) | 5 | V | X | X | ◯ | ◯ | ◯ |
| 5 | (B) | 5 | V | X | X | X | X | ◯ |
| 1.8 | (A) | 1.8 | V | X | X | ◯ | ◯ | ◯ |
| 1.8 | (B) | 1.8 | V | X | X | X | ◯ | ◯ |

| | | | | | | | |
|---|---|---|---|---|---|---|---|
| 1.5 | 1.5 | V | X | X | X | X | ◯ |
| 1.2 | 1.2 | V | X | X | X | ◯ | ◯ |
| 0.6 | 0.6 | V | X | X | X | X | ◯ |

In some examples, the tracking device, other wireless communication device, and/or physical characteristic sensor may be coupled to the reserve power rail, which may allow the tracking device, other wireless communication device, and/or physical characteristic sensor to function while the electronic device is in an off state. The tracking device, other wireless communication device, and/or physical characteristic sensor may accordingly consume power from a power source (e.g., battery) that may be powering the reserve power rail and/or another selected resource(s) or component(s) (e.g., clock, BIOS memory, etc.). In some cases, the tracking device, other wireless communication device, and/or physical characteristic sensor may reduce the period in which the reserve power rail may be active. For instance, a tracking device, other wireless communication device, and/or physical characteristic sensor may consume more power (e.g., 4 times more power) than a clock, which may reduce the active period for the reserve power rail (e.g., to 6 months from 2.5 years). Some examples of the techniques described herein may be utilized to reduce the power consumption for a tracking device, other wireless communication device, and/or physical characteristic sensor.

Throughout the drawings, identical or similar reference numbers may designate similar, but not necessarily identical, elements. The figures are not necessarily to scale, and the size of some parts may be exaggerated to more clearly illustrate the example shown. Moreover, the drawings provide examples in accordance with the description; however, the description is not limited to the examples provided in the drawings.

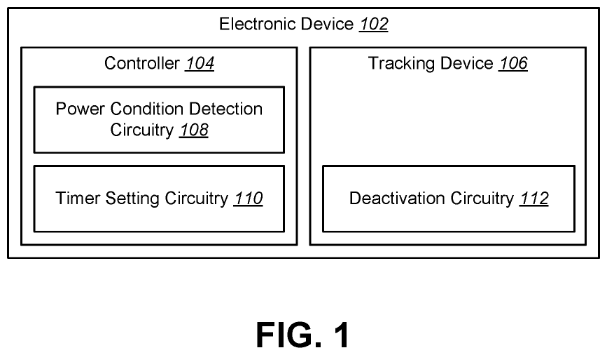

FIG. 1 is a block diagram of an example of an electronic device 102 that may be utilized for tracking device deactivation control. Examples of the electronic device 102 may include computing devices, laptop computers, desktop computers, smartphones, tablet devices, wireless communication devices, game consoles, vehicles with electronic components, aircraft, drones, robots, smart appliances, etc. The electronic device 102 may include a tracking device 106 and/or a controller 104. In some examples, the electronic device 102 (e.g., controller 104 and/or tracking device 106) may perform one, some, or all of the functions, operations, elements, procedures, etc., described in one, some, or all of FIG. 1-5.

The tracking device 106 may include circuitry (e.g., integrated circuitry, semiconductor circuitry, electronic component(s), etc.). For example, the tracking device 106 may include digital logic circuitry (e.g., a tracking device processor), transistors, memory, etc. In some examples, the tracking device 106 may execute instructions and/or code to perform an operation or operations. Examples of the tracking device 106 may include wireless tracking devices, Bluetooth trackers, etc. In some examples, the tracking device 106 may include a transmitter and/or a receiver. For instance, the tracking device 106 may include a transmitter to transmit a wireless signal or signals (e.g., beacons, advertising signal(s), Bluetooth beacon, Bluetooth communication signal, Wi-Fi signal, cellular signal, etc.). For example, the wireless signal or signals may be utilized by another device (e.g., a paired device) to detect, locate, and/or record a location for the tracking device 106 (and/or the electronic device 102). For instance, the other device (e.g., paired device) may detect when the tracking device 106 is within wireless range and/or may store location data (e.g., global positioning system (GPS) data of the paired device) associated with the tracking device 106 when the tracking device 106 is within wireless range. In some examples, the tracking device 106 may include a receiver to receive a signal or signals. For example, the tracking device 106 may output a sound or may instruct the electronic device 102 to output a sound in response to a received signal. In some examples, the tracking device 106 may include and/or may be coupled to an antenna or antennas for transmitting and/or receiving electromagnetic signal(s).

The controller 104 may include circuitry (e.g., integrated circuitry, semiconductor circuitry, electronic component(s), etc.). For example, the controller 104 may include digital logic circuitry (e.g., a controller processor), transistors, memory, etc. In some examples, the controller 104 may execute instructions and/or code to perform an operation or operations. In some examples, the controller 104 may be separate from the tracking device 106. In some examples, the controller 104 may be included in the tracking device 106. In some examples, the controller 104 may be an embedded controller. In some examples, the controller 104 may control an aspect or aspects of electronic device 102 operation. For example, the controller 104 may control activation and/or deactivation of a power rail or power rails of the electronic device 102.

In some examples, the controller 104 may detect a power condition of the electronic device 102. A power condition may be a condition relating to power provided for electronic device 102 operation. For example, a power condition may relate to power source (e.g., battery) charge, voltage, current, milliamp hours (mAh), watts, spent energy, etc. In some examples, a power condition may be expressed as a threshold (e.g., charge threshold, voltage threshold, current threshold, spend energy threshold, etc.). For instance, a power condition may be detected if a battery charge is below a threshold, if an amount of spent energy is above a threshold, etc. The controller 104 and/or another component or components of the electronic device 102 may determine (e.g., measure and/or calculate) a measurement or measurements that may be utilized to detect the power condition. For example, the controller 104 and/or another component of the electronic device 102 may determine battery charge by performing current integration (e.g., coulomb counting), comparing a battery voltage to a discharge curve, and/or by filtering (e.g., Kalman filtering) current and/or voltage measurements. In some examples, the power condition may be determined for a battery (e.g., a main battery) of the electronic device and/or for a battery that powers a rail that powers the controller 104.

In some examples, the controller 104 may include power condition detection circuitry 108 to detect the power condition. For example, the power condition detection circuitry 108 may detect the power condition by comparing a charge measurement to a charge threshold, comparing a voltage measurement to a voltage threshold, etc. The comparison may be carried out using digital logic (e.g., comparing digital values with logic circuitry) and/or using an analog technique (e.g., comparator circuitry). In some examples, the power condition detection circuitry 108 may detect the power condition by determining that a charge measurement is less than a charge threshold. Examples of the charge threshold may include 10%, 5%, 3%, 2%, 1%, etc. In some examples, the power condition detection circuitry 108 may detect the power condition by determining that a voltage measurement from a power rail (e.g., a non-reserve power rail) is less than a voltage threshold (e.g., 5 V, 3 V, 1 V, etc.). In a case that a threshold is satisfied, the power condition detection circuitry 108 may indicate that a power condition is detected. In some examples, a combination of thresholds or detection criteria may be utilized to detect the power condition.

The controller 104 may set a timer to deactivate the tracking device 106 in response to detecting the power condition. Setting a timer may include initiating a timer and/or commanding a timer to be set and/or started. For example, the controller 104 may command the tracking device 106 to set a timer. In some examples, the controller 104 may include timer setting circuitry 110. The timer setting circuitry 110 may set the timer and/or may command the tracking device to set the timer. In some examples, the timer amount (e.g., a week, a month, 2 months, 3 months, 6 months, a year, etc.) may be static.

In some examples, the controller 104 may deactivate a power rail or rails in response to detecting the power condition. For example, the controller 104 may deactivate a power rail that powers the controller 104 in response to determining that the battery charge is less than a threshold. For instance, after setting the timer to deactivate the tracking device 106, the controller 104 may deactivate a power rail that powers the controller 104. Deactivating the power rail that powers the controller 104 may result in deactivating the controller 104 in some examples. For instance, the controller 104 may deactivate all power rails (e.g., all power rails or any remaining active power rail(s)), except for the reserve power rail in response to the detecting the power condition and/or after setting the timer. In some examples, deactivating the power rail that powers the controller 104 may limit the logic capabilities of the electronic device 102. Accordingly, it may be beneficial to set the timer before deactivating the controller 104.

In some examples, the controller 104 (e.g., timer setting circuitry 110) may determine a timer amount based on factor data. For instance, the timer amount may be determined based on a factor or factors indicated by the factor data. Examples of factors may include location, last time located, date, time, battery performance, etc.

For instance, if the tracking device 106 is outside of an area (e.g., home, office, list of previous locations, etc.), the timer amount may be extended or a greater timer amount (e.g., greater by a few days, a week, a month, two months, etc.) than a default timer amount (e.g., a week, a month, 2 months, 3 months, 6 months, a year, etc.) may be selected. Extending the timer amount may enable a greater probability of being located when the electronic device 102 is away from an established area or areas (e.g., the electronic device 102 has been taken on a trip or has been stolen). In some examples, the electronic device 102 (e.g., controller 104, timer setting circuitry 110, and/or tracking device 106) may determine and/or receive the location factor. For example, the electronic device 102 (e.g., controller 104, timer setting circuitry 110, and/or tracking device 106) may include a GPS receiver and/or may receive coordinate data from another device (e.g., a paired device). The electronic device 102 may determine and/or receive indications of areas outside of which the timer amount may be extended. For instance, the electronic device 102 may receive area indication(s) from user input and/or may determine area indication(s) by determining area(s) in which the electronic device 102 is often located or has been located for an amount of time.

In some examples, the timer amount may be determined based on a last time located. For example, the electronic device 102 (e.g., controller 104, timer setting circuitry 110 and/or tracking device 106) may determine that the electronic device 102 was located (e.g., the tracking device 106 was within wireless range and/or paired with another device) within an amount of time (e.g., hour, 5 hours, day, week, etc.) and/or that the electronic device 102 has not moved since a last time that the electronic device 102 was located. In these cases, the timer amount may be reduced or a lesser timer amount (e.g., less by a few days, a week, a month, two months, etc.) than a default timer amount may be selected.

In some examples, the timer amount may be determined based on a battery performance. For example, the electronic device 102 (e.g., controller 104, timer setting circuitry 110 and/or tracking device 106) may determine that a battery has lasted longer than anticipated or has lasted for a shorter time than anticipated. In a case that the battery performance has been better than expected, the timer amount may be extended or a greater timer amount than a default timer amount may be selected. In a case that the battery performance has been shorter than expected, the timer amount may be reduced or a lesser timer amount than a default timer amount may be selected.

In some examples, the timer amount may be determined based on a date. For example, the electronic device 102 (e.g., controller 104, timer setting circuitry 110 and/or tracking device 106) may determine that the tracking device 106 would be deactivated on a prohibited date (e.g., weekend, weekday, holiday, etc.). In a case that the tracking device 106 would be deactivated on a prohibited date, the timer amount may be extended or reduced to avoid the prohibited date.

In some examples, the tracking device 106 may set and/or start a timer in response to the command from the controller 104. A timer may be mechanism (e.g., circuitry) and/or procedure for tracking the passage of an amount of time. For example, the tracking device 106 may include a clock or may monitor a separate electronic device 102 clock (e.g., RTC) for the passage of an amount of time. A timer may expire when the amount of time is reached or has passed. In some examples, the tracking device 106 may monitor the timer to deactivate at the expiration of the timer. For instance, the tracking device 106 may utilize the clock to detect a timer expiration by counting down from the timer amount to 0, counting up to the timer amount from 0, and/or determining when the timer amount is reached or passed based on an initial time (e.g., when the timer was set) and a current time (e.g., based on a difference between initial time and current time). When the timer expiration is detected, the tracking device 106 may deactivate. For example, the tracking device 106 may switch power off to the tracking device 106 and/or may stop operating. In some examples, the tracking device 106 may include deactivation circuitry 112 to deactivate the tracking device 106. Examples of the deactivation circuitry 112 may include a power switch, logic gate, multiplexer, transistor(s), etc., that may deactivate the tracking device 106, reduce tracking device 106 power consumption, and/or stop tracking device 106 operation. The tracking device 106 may deactivate in response to the timer expiration.

In some examples, the electronic device 102 may include additional components and/or some of the components described herein may be removed and/or modified without departing from the scope of this disclosure. In some examples, the electronic device 102 (e.g., electronic device 102, controller 104, and/or tracking device 106) may include a processor and/or a memory. The processor may be any of a central processing unit (CPU), a semiconductor-based microprocessor, graphics processing unit (GPU), field-programmable gate array (FPGA), an application-specific integrated circuit (ASIC), and/or other hardware device suitable for retrieval and execution of instructions stored in the memory. The processor may fetch, decode, and/or execute instructions stored in the memory. The memory may be any electronic, magnetic, optical, or other physical storage device that contains or stores electronic information (e.g., instructions and/or data). Thus, the memory may be, for example, Random Access Memory (RAM), Electrically Erasable Programmable Read-Only Memory (EEPROM), Dynamic Random Access Memory (DRAM), magnetoresistive random-access memory (MRAM), phase change RAM (PCRAM), memristor, flash memory, a storage device, and/or an optical disc, etc. In some examples, the memory may be a non-transitory tangible machine-readable storage medium, where the term “non-transitory” does not encompass transitory propagating signals. The processor may be in electronic communication with the memory. In some examples, a processor and/or memory of a controller 104 and/or of a tracking device 106 may be combined with or separate from an applications processor (e.g., CPU) of the electronic device 102.

In some examples, the electronic device 102 may include an input/output interface (not shown) through which the electronic device 102 may communicate with an external device or devices (not shown). The input/output interface may include hardware and/or machine-readable instructions to enable the processor to communicate with the external device or devices. The input/output interface may enable a wired or wireless connection to the external device or devices. In some examples, the input/output interface may further include a network interface card and/or may also include hardware and/or machine-readable instructions to enable the processor to communicate with various input and/or output devices, such as a keyboard, a mouse, a display, another apparatus, electronic device, computing device, etc., through which a user may input instructions and/or indications into the electronic device 102.

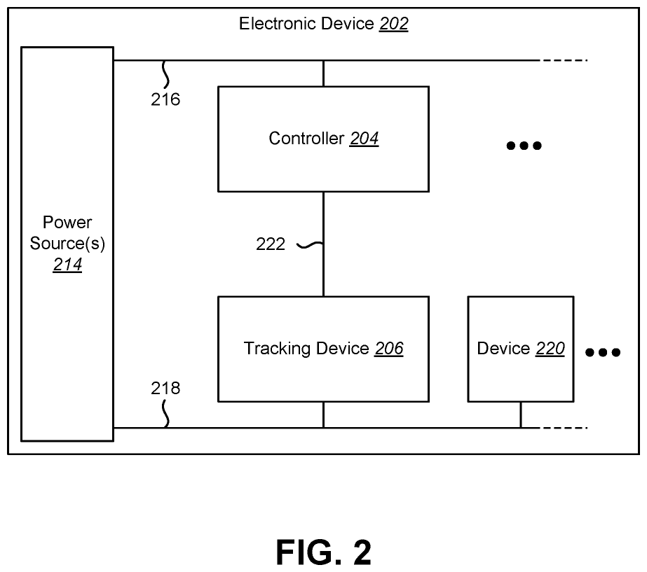

FIG. 2 is a block diagram of an example of an electronic device 202 that may be utilized for tracking device deactivation control. The electronic device 202 of FIG. 2 may be an example of the electronic device 102 as described in FIG. 1. The electronic device 202 may include a tracking device 206 and/or a controller 204. The controller 204 of FIG. 2 may be an example of the controller 104 as described in FIG. 1. The tracking device 206 of FIG. 2 may be an example of the tracking device 106 as described in FIG. 1. In some examples, the electronic device 202 (e.g., controller 204 and/or tracking device 206) may perform one, some, or all of the functions, operations, elements, procedures, etc., described in one, some, or all of FIG. 1-5. In some examples, a wireless communication device and/or a physical characteristic sensor may be included in the electronic device 202 instead of the tracking device 206.

The electronic device 202 may include a power source or power sources 214. A power source may be a device or connection that provides power. Examples of the power source(s) 214 include batteries, power supplies, etc. The electronic device 202 may include a first power rail 216 and a second power rail 218. In some examples, the second power rail 218 may be a reserve power rail to power the tracking device 206. For instance, the second power rail 218 may provide voltage and/or current to the tracking device 206. In some examples, the electronic device 202 may include an additional power rail or power rails. In some examples, the electronic device 202 may include multiple power rails. In some examples, multiple power rails may be associated with a processor (e.g., central processing unit (CPU)) of the electronic device 202. In some examples, some power rails may provide different voltages depending on processor demands such as 1.8 Volts (V), 3.3 V, and/or 5 V. Other chipsets may utilize multiple independent rails, which may be enabled and/or disabled based on a current power state of the electronic device 202. Examples of power rails and voltages that may be utilized are given in Table (1). In some examples, the first power rail 216 may be coupled to and/or provide power to an additional device or devices (not shown in FIG. 2). In some examples, the second power rail 218 may be coupled to and/or provide power to an additional device 220 or devices. For example, the electronic device 202 may include a device 220. In some examples, the second power rail 218 may be a shared power rail to provide power to multiple devices. In some examples, the device 220 may be a clock (e.g., RTC). In some examples, a memory (e.g., BIOS memory) may be coupled to and/or powered by the second power rail 218. In some examples, the second power rail may provide 3.3 V or another voltage. In some examples, the tracking device 206, the device 220, and/or another device or devices may also be coupled to the first rail 216 and/or to another rail or rails. For instance, the first rail 216 and/or another rail or rails may provide power to the tracking device 206 (and/or to the device 220) when the electronic device 202 is in an active state, which may conserve power provided by the second power rail 218.

In some examples, the first power rail 216 and the second power rail 218 may be powered by one power source 214 (e.g., one battery, one power supply, etc.). In some examples, the controller 204 may be coupled to the first power rail 216 and the tracking device 206 may be coupled to the second power rail 218.

In some examples, the electronic device 202 may include a first power source and a second power source. For instance, the power source(s) 214 may include a first power source that powers the first power rail 216 and a separate second power source that powers the second power rail 218. For example, the second power source may provide power to the tracking device 206. In some examples, the first power source may be a first battery (e.g., a main battery for the electronic device 102) and the second power source may be a second battery (e.g., an auxiliary battery, a coin cell battery, etc.). For example, the second power source may be smaller than the first power source. In some examples, the second power source may provide power to another device 220 or devices on the second power rail 218. For example, the second power source may provide power to a clock (e.g., RTC). In some examples, the tracking device 206, a wireless communication device, a physical characteristic sensor and/or another device 220 may be coupled to the second power rail 218.

In some examples, the controller 204 may detect a power condition of the electronic device 202 as described in FIG. 1. In some examples, the controller 204 may determine the timer amount based on factor data as described in FIG. 1. In some examples, the controller 204 may detect the power condition and set the timer before the first power rail 216 discontinues powering the controller 204. For example, the controller 204 may determine that a power source 214 charge is below a threshold (e.g., 1%). The controller 204 may set the timer and may deactivate (e.g., turn off) the first power rail 216.

In some examples, the controller 204 may send a message 222 (e.g., command, instruction, code, etc.) to the tracking device indicating the power condition to start the timer in response to detecting the power condition. For example, the controller 204 may send the message 222 on an internal bus or wire of the electronic device 202. In some examples, the tracking device 206 may start the timer in response to the message indicating the power condition received from the controller 204.

As described herein, the tracking device 206, a wireless communication device, a physical characteristic sensor, and/or another device 220 or devices may be coupled to the second power rail 218 (e.g., a reserve power rail). The second power rail 218 may enable the tracking device 206, wireless communication device, physical characteristic sensor, and/or another device 220 or devices to remain powered until a timer expiration.

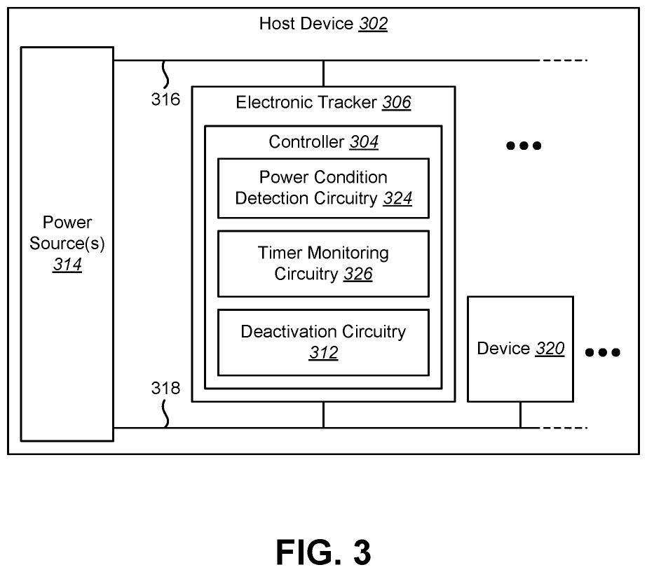

FIG. 3 is a block diagram of an example of a host device 302 that may be utilized for deactivation control. A host device may be an electronic device that hosts another device. For example, the host device 302 may provide power for an electronic tracker 306. In some examples, the host device 302 of FIG. 3 may be an example of the electronic device 102 as described in FIG. 1. The host device 302 may include an electronic tracker 306 and/or a controller 304. For example, the electronic tracker 306 may include the controller 304. The controller 304 of FIG. 3 may be an example of the controller 104 as described in FIG. 1. An electronic tracker may be a device that can be tracked with wireless signaling. In some examples, the electronic tracker 306 of FIG. 3 may be an example of the tracking device 106 as described in FIG. 1. In some examples, the host device 302 (e.g., controller 304 and/or electronic tracker 306) may perform one, some, or all of the functions, operations, elements, procedures, etc., described in one, some, or all of FIG. 1-5.

The host device 302 may include a power source or power sources 314. Examples of the power source(s) 314 include batteries, power supplies, etc. The host device 302 may include a first power rail 316 and a second power rail 318. The electronic tracker 306 may be coupled to the first power rail 316 and to the second power rail 318 of the host device 302. In some examples, the second power rail 318 may be a reserve power rail to power the electronic tracker 306. For instance, the second power rail 318 may provide voltage and/or current to the electronic tracker 306. In some examples, the host device 302 may include an additional power rail or power rails. In some examples, the first power rail 316 may be coupled to and/or provide power to an additional device or devices (not shown in FIG. 3). In some examples, the second power rail 318 may be coupled to and/or provide power to an additional device 320 or devices. For example, the host device 302 may include a device 320. In some examples, the device 320 may be a clock (e.g., RTC). In some examples, a memory (e.g., BIOS memory) may be coupled to and/or powered by the second power rail 318. In some examples, the electronic tracker 306, the device 320, and/or another device or devices may also be coupled to the first power rail 316 and/or to another rail or rails. For instance, the first power rail 316 and/or another rail or rails may provide power to the electronic tracker 306 (and/or to the device 320) when the host device 302 is in an active state, which may conserve power provided by the second power rail 318.

In some examples, the first power rail 316 and the second power rail 318 may be powered by one power source 314 (e.g., one battery, one power supply, etc.). In some examples, the host device 302 may include a first power source and a second power source. For instance, the power source(s) 314 may include a first power source that powers the first power rail 316 and a separate second power source that powers the second power rail 318. In some examples, the first power source may be a first battery (e.g., a main battery for the electronic device 102) and the second power source may be a second battery (e.g., an auxiliary battery, a coin cell battery, etc.). In some examples, the second power source may provide power to another device 320 or devices on the second power rail 318. For example, the second power source may provide power to a clock (e.g., RTC) when the host device is in an off state.

In some examples, the electronic tracker 306 (e.g., the controller 304) may include power condition detection circuitry 324. The power condition detection circuitry 324 may be circuitry to detect a power condition of the host device. In some examples, the power condition detection circuitry 324 may detect the power condition of the host device 302 as described in FIG. 1. For example, the power condition detection circuitry 324 may detect the power condition by detecting a decrease in power on the first power rail 316. For instance, the power condition detection circuitry 324 may compare a voltage measurement, a current measurement, and/or a power measurement (e.g., power calculation) to a threshold or thresholds. For example, if the power condition detection circuitry 324 detects that a voltage of the first power rail 316 has decreased below a threshold (e.g., 3 V, 2 V, 1 V, 0.5 V, etc.), the power condition detection circuitry 324 may detect the power condition.

In some examples, the electronic tracker 306 (e.g., the controller 304) may include timer monitoring circuitry 326. The timer monitoring circuitry 326 may be circuitry to monitor a timer in response to a power condition of the host device 302. For example, the power condition detection circuitry 324 and the timer monitoring circuitry 326 may be included in the controller 304 of the electronic tracker 306. In some examples, the timer monitoring circuitry 326 may monitor the timer as described in FIG. 1. In some examples, the timer monitoring circuitry 326 may set, start, and/or monitor the timer in response to a power condition detected by the power condition detection circuitry 324. For instance, the timer monitoring circuitry 326 may detect a timer expiration.

In some examples, the electronic tracker 306 may include deactivation circuitry 312. The deactivation circuitry 312 may be circuitry to deactivate the electronic tracker 306 in response to the timer expiration. For example, the deactivation circuitry 312 may be an example of the deactivation circuitry 112 described in FIG. 1 and/or may deactivate the electronic tracker 306 as described in FIG. 1.

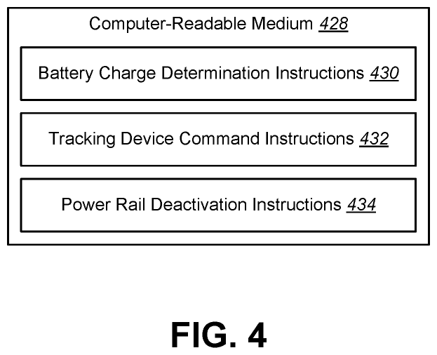

FIG. 4 is a block diagram illustrating an example of a computer-readable medium 428 for controlling device deactivation. The computer-readable medium 428 may be a non-transitory, tangible computer-readable medium 428. The computer-readable medium 428 may be, for example, RAM, EEPROM, a storage device, an optical disc, and the like. In some examples, the computer-readable medium 428 may be volatile and/or non-volatile memory, such as DRAM, EEPROM, MRAM, PCRAM, memristor, flash memory, and the like. In some examples, the computer-readable medium 428 described in FIG. 4 may be an example of memory for a controller 104 and/or tracking device 106 described in FIG. 1. In some examples, code (e.g., data and/or executable code or instructions) of the computer-readable medium 428 may be transferred and/or loaded to memory or memories of a controller and/or tracking device.

The computer-readable medium 428 may include code (e.g., data and/or executable code or instructions). For example, the computer-readable medium 428 may include battery charge determination instructions 430, tracking device command instructions 432, and/or power rail deactivation instructions 434.

In some examples, the battery charge determination instructions 430 may be instructions when executed cause a controller (e.g., an embedded controller) of an electronic device to determine whether a battery charge is less than a threshold. In some examples, this may be accomplished as described in FIG. 1.

In some examples, the tracking device command instructions 432 may be instructions when executed cause the controller (e.g., the embedded controller) of the electronic device to command a tracking device to initiate a deactivation timer in response to determining that the battery charge is less than the threshold. In some examples, this may be accomplished as described in FIG. 1.

In some examples, the power rail deactivation instructions 434 may be instructions when executed cause the controller (e.g., the embedded controller) of an electronic device to deactivate a power rail that powers the controller in response to determining that the battery charge is less than the threshold. In some examples, this may be accomplished as described in FIG. 1.

In some examples, the tracking device command instructions 432 and the power rail deactivation instructions 434 may be instructions when executed cause the controller (e.g., the embedded controller) of the electronic device to command the tracking device to initiate the deactivation timer before causing the controller to deactivate the power rail. In some examples, this may be accomplished as described in FIG. 1 and/or FIG. 2.

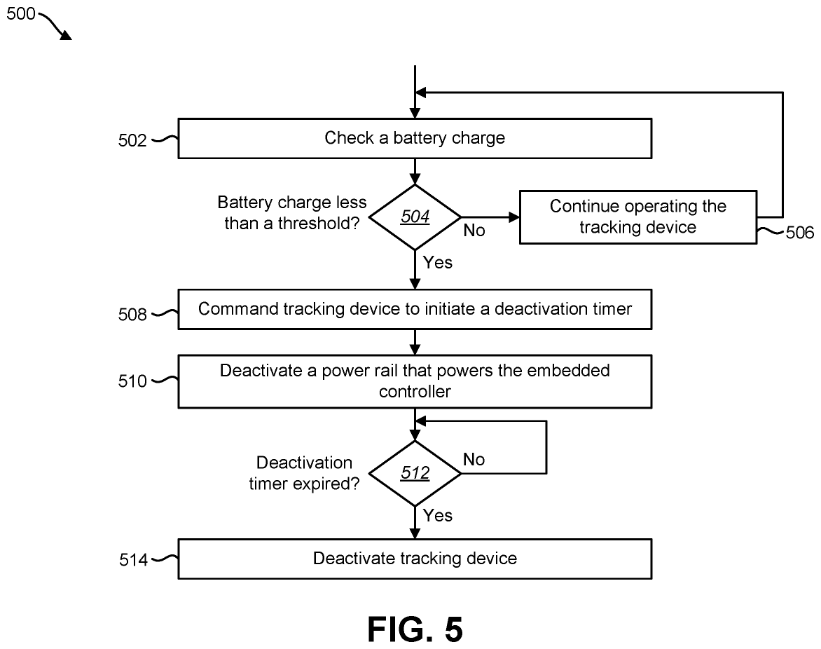

FIG. 5 is a flow diagram illustrating an example of a method 500 for controlling device deactivation. For instance, the method 500 may provide an approach for dynamically setting a timer. The method 500 and/or an element or elements of the method 500 may be performed by an electronic device. For example, an element or elements of the method 500 may be performed by the electronic device 102 described in FIG. 1, the controller 104 described in FIG. 1, the electronic device 202 described in FIG. 2, the controller 204 described in FIG. 2, the electronic tracker 306 described in FIG. 3, the controller 304 described in FIG. 3, and/or the host device 302 described in FIG. 3, any of which may be referred to generally as an “electronic device” in FIG. 5. In some examples, the method 500 may be performed using an instruction or instructions described in FIG. 4. In some examples, the method 500 may be performed by an embedded controller. For instance, an embedded controller may activate (e.g., wake up, boot up, etc.) after an initial power on. The embedded controller may control a power rail or power rails. The electronic device may operate a tracking device. For example, the electronic device may supply power to a tracking device for tracking device operation.

An electronic device may check 502 a battery charge. In some examples, checking 502 a battery charge may be performed as described in FIG. 1. For example, the electronic device may determine a battery charge. In some examples, the embedded controller may check (e.g., periodically check, regularly check, etc.) the status of the battery.

The electronic device may determine 504 whether a battery charge is less than a threshold (e.g., 1%). In some examples, determining 504 whether a battery charge is less than a threshold may be performed as described in FIG. 1. For example, the electronic device (e.g., embedded controller) may determine 504 whether a battery charge of a main battery of the electronic device or a battery that powers an embedded controller is less than a threshold. In a case that the battery charge is not less than the threshold, the electronic device may continue 506 operating the tracking device. For example, the electronic device may continue supplying power to the tracking device for tracking device operation. In some examples, the electronic device may notify a tracking device, other wireless communication device, and/or physical characteristic sensor that the tracking device, other wireless communication device, and/or physical characteristic sensor may operate without setting a timer (e.g., deactivation timer) in response to determining that the battery charge is not less than the threshold. The electronic device may return (e.g., may periodically return) to checking 502 the battery charge and determining 504 whether the battery charge is less than the threshold.

In a case that the battery charge is less than the threshold, the electronic device may command 508 a tracking device to initiate a deactivation timer. In some examples, this may be accomplished as described in FIG. 1. For example, the electronic device may command 508 the tracking device to initiate a 30-day deactivation timer. The tracking device may initiate (e.g., set and start) the deactivation timer and/or may begin monitoring the deactivation timer.

The electronic device (e.g., embedded controller) may deactivate 510 a power rail that powers the embedded controller. In some examples, this may be accomplished as described in FIG. 1. For example, the electronic device may deactivate all power rails except for a reserve power rail.

The electronic device (e.g., tracking device) may determine 512 whether the deactivation timer is expired. In some examples, determining 512 whether the deactivation timer is expired may be performed as described in FIG. 1. For example, the electronic device (e.g., tracking device) may determine whether a current time has reached or passed an expiration time, whether the timer amount has been reached or passed, whether a count or countdown has reached or passed a threshold, etc. In a case that the deactivation timer is not expired, the electronic device (e.g., tracking device) may continue to monitor the deactivation timer and/or may return (e.g., periodically return) to determining 512 whether the deactivation timer is expired. The tracking device may continue to operate during deactivation timer monitoring (e.g., countdown, timer checking, etc.).

In a case that the deactivation timer is expired, the electronic device (e.g., tracking device) may deactivate 514 the tracking device. In some examples, deactivating 514 the tracking device may be performed as described in FIG. 1. For example, the tracking device may switch off and/or stop operating. In some examples, the electronic device may continue to operate (e.g., power) another device or devices (e.g., clock, memory, etc.) after deactivation of the tracking device. For instance, the electronic device may continue to provide power on a reserve power rail for a device or devices while a battery can supply power to the reserve power rail.

In some examples, a wireless communication device, a physical characteristic sensor, and/or another device may be utilized instead of a tracking device (e.g., tracking device 106, tracking device 206, electronic tracker 306) in accordance with the description herein. For example, a physical characteristic sensor may be coupled to a reserve power rail. In some examples, the physical characteristic sensor may remain powered by the reserve power rail for an amount of time. This may allow a user to trigger a wake event for an electronic device. For instance, a timer amount may be provided for the physical characteristic sensor to draw power from the reserve power rail, which may allow a user to utilize the physical characteristic sensor (e.g., touch screen, touch pad, etc.) to trigger a wake event during the timer amount. Accordingly, the physical characteristic sensor may function to detect a wake event, even while the electronic device is in a low-power operating state (e.g., standby, sleep, off, etc.). In some examples, the physical characteristic sensor may include a timer and/or may monitor a separate timer. When the timer for the physical characteristic sensor expires, the physical characteristic sensor may be deactivated or turned off, which may allow the reserve power rail to continue to providing power to another device or devices (e.g., clock, memory, etc.). In some examples, the physical characteristic sensor may be powered by another rail when the electronic device is in an active or “on” operating state, and may be placed on the reserve power rail when the electronic device transitions to another operating state (e.g., standby, sleep, off, etc.). In some examples, the physical characteristic sensor may perform a function or functions described herein instead of, or in addition to, a tracking device or electronic tracker.

Some examples of the techniques described herein may enable an embedded controller to notify the tracking device or other embedded wireless communication device that the embedded controller is about to begin a reserve power mode where the reserve power rail is active without any other power rail being active. During this notification, the embedded controller may notify the tracking device or other embedded wireless communication device of a timer amount (e.g., a period for which the tracking device or other embedded wireless communication device may operate while in the reserve power mode). The tracking device or other embedded wireless communication device may start an internal timer. When the timer expires, the tracking device or other embedded wireless communication device may place itself into an off state, which may allow another device (e.g., clock, RTC, and/or memory, etc.) that shares the reserve power rail to have access to the remaining battery capacity.

Some examples of the techniques described herein may be beneficial to allow a tracking device or other embedded wireless communication device to be powered on a reserve power rail for a period while preserving a power source to maintain another device or devices powered on the reserve power rail. For instance, an RTC may be powered on the reserve power rail for approximately 2.5 years on a battery charge without a tracking device consuming power. If the tracking device is allowed to consume power on the reserve power rail indefinitely, the period of operation on the battery charge may be reduced to approximately 6 months. In an example of the techniques described herein, a tracking device or other embedded wireless communication device may be dynamically powered off on the shared reserve power rail, which may provide a period of operation of the RTC of approximately two years, and a period of operation of the tracking device, other wireless communication device, and/or physical characteristic sensor of approximately 6 months.

As used herein, the term “and/or” may mean an item or items. For example, the phrase “A, B, and/or C” may mean any of: A (without B and C), B (without A and C), C (without A and B), A and B (but not C), B and C (but not A), A and C (but not B), or all of A, B, and C.

While various examples are described herein, the disclosure is not limited to the examples. Variations of the examples described herein may be within the scope of the disclosure. For example, operations, functions, aspects, or elements of the examples described herein may be omitted or combined.

1. An electronic device, comprising:
a tracking device; and
a controller, wherein the controller is to:
detect a power condition of the electronic device; and
set a timer to deactivate the tracking device in response to detecting the power condition.

2. The electronic device of claim 1, further comprising a first power source and a second power source, wherein the second power source is to provide power to the tracking device.

3. The electronic device of claim 2, wherein the second power source is smaller than the first power source and is to provide power to a clock.

4. The electronic device of claim 1, further comprising a first power rail and a second power rail, wherein the second power rail is a reserve power rail to power the tracking device.

5. The electronic device of claim 4, wherein the first power rail and the second power rail are powered by one power source.

6. The electronic device of claim 4, wherein the controller is coupled to the first power rail and the tracking device is coupled to the second power rail.

7. The electronic device of claim 1, wherein the tracking device is to start the timer in response to a message indicating the power condition received from the controller.

8. The electronic device of claim 1, wherein the controller is to determine a timer amount based on factor data.

9. An electronic tracker, comprising:
timer monitoring circuitry to monitor a timer in response to a power condition of a host device; and
deactivation circuitry to deactivate the electronic tracker in response to a timer expiration, wherein the electronic tracker is coupled to a first power rail and a second power rail of the host device.

10. The electronic tracker of claim 9, further comprising power condition detection circuitry to detect the power condition of the host device.

11. The electronic tracker of claim 10, wherein the power condition detection circuitry is to detect the power condition by detecting a decrease in power on the first power rail.

12. The electronic tracker of claim 10, wherein the timer monitoring circuitry and the power condition detection circuitry are included in a controller of the electronic tracker.

13. A non-transitory tangible computer-readable medium comprising instructions when executed cause a controller of an electronic device to:
determine whether a battery charge is less than a threshold; and
command a tracking device to initiate a deactivation timer in response to determining that the battery charge is less than the threshold.

14. The computer-readable medium of claim 13, wherein the instructions when executed further cause the controller to deactivate a power rail that powers the controller in response to determining that the battery charge is less than the threshold.

15. The computer-readable medium of claim 14, wherein the instructions when executed cause the controller to command the tracking device to initiate the deactivation timer before causing the controller to deactivate the power rail.
